(19) United States
(12) Patent Application Publication
(10) Pub. No.: US 2002/0013769 A1
(43) Pub. Date: Jan. 31, 2002

(54) Automated billing type information providing system

(76) Inventor: Shigeo Murase, Kanagawa (JP)

Correspondence Address: SUGHRUE, MION, ZINN, MACPEAK & SEAS, 2100 Pennsylvania Avenue, N.W., Washington, DC, 20037, US

(21) Appl. No.: 09/772,980

(22) Filed: Jan. 31, 2001

(30) Foreign Application Priority Data
Jun. 21, 2000 (JP) 2000-186401

(51) Int. Cl. G06F 17/60

(52) U.S. Cl. 705/40

(57) ABSTRACT

An automated billing type information providing system capable of utilizing the Internet, etc. simply by paying a charge with a prepaid card, etc. has a monitor imparted to a user and connected to a provider through a telecommunication line via a server, a signal receiving unit for receiving video signals output to the monitor, and a billing unit for integrating Internet use time through the telecommunication line or a projection time for which the video signals are projected on the monitor through the signal receiving unit, and calculating the use charge based on the results of this integration. A user pays the use charge calculated by the billing unit and is thereby allowed to utilize the Internet through the telecommunication line and to at least view the video signals on the monitor.

### BACKGROUND OF THE INVENTION

1. Field of the Invention

The present invention generally relates to an automated billing type information providing system device, and more particularly to a novel improvement designed to readily allow utilization of information on the Internet, etc. at low cost.

2. Description of the Related Art

FIG. 4 shows a configuration of, e.g., a prepaid card insertion type TV that may be exemplified as a conventional system of this type. To be specific, referring to FIG. 4, a TV set designated by 1 is placed on a bedside stand 2 in a room of, e.g., a hospital.

A billing machine 3 is connected to the TV, and it is constructed so that when a patient inserts a prepaid card into a card insertion slot 4, the power source of the TV 1 is switched ON, and the billing machine 3 begins to calculate a use charge corresponding to the time used.

There were also cash insertion type TV's besides the prepaid card insertion type TV's.

Since the conventional system is constructed as described above, the following problems arise. Namely, application of this system is limited only to TV's in a pure sense, and even though video tapes can be viewed with this system, it is incapable being used to utilize, the Internet, e-mails, chat-rooms, etc.

Further, although the TV's such as described above were to be installed in each room of a hospital, if the prepaid card insertion type TV could be loaned to, e.g., individual homes, this might have been useful especially to senior people. However, this type of system was not constructed.

### SUMMARY OF THE INVENTION

It is a primary object of the present invention, which was devised to obviate the above problems, to provide an automated billing type information providing system capable of not only accepting the loan of a TV monitor by the payment of a use charge, particularly with a prepaid card, etc., but also allowing utilization of the Internet, etc.

To accomplish the above object, according to one aspect of the present invention, an automated billing type information providing system comprises a monitor loaned to a user and connected to a provider through a telecommunication line via a server, a signal receiving unit for receiving video signals output to the monitor, and a billing unit for integrating Internet use time through the telecommunication line or projection time for which video signals are projected on the monitor through the signal receiving unit, and calculating the use charge based on the result of this integration. A user pays the use charge calculated by the billing unit and is thereby allowed to utilize the Internet through the telecommunication line and to at least view the video signals on the monitor. In the above automated billing type information providing system, the telecommunication line may be based on a LAN system. The monitors may be installed in individual homes, and a single server for a plurality of homes may be provided outside the homes. A plurality of monitors may also be installed in a hospital ward, with a server installed in the ward. Further, the billing unit may be installed together with the monitor on the user's side, and the use charges paid using a prepaid card system or the billing unit may be constructed so that the results of the integration are transmitted to the provider through the telecommunication line, and the user is billed for the use charges based on the results of the integration transmitted to the provider. Alternatively, the provider may be connected to a financial institution or a non-bank financial institution, so that data representing the use charges can be transmitted to the financial institution or the non-bank financial institution and the use charges automatically debited from the user's account. Further, the billing unit may be installed together with the monitor on the user's side, and the use charges may be paid in cash.

### BRIEF DESCRIPTION OF THE DRAWINGS

In the accompanying drawings:

FIG. 1 is a view schematically showing an architecture of an automated billing type information providing system according to the present invention;

FIG. 2 is a flowchart showing a flow of processes from the start of a user using this system to the collection of a charge in the automated billing type information providing system of the present invention;

FIG. 3 is a flowchart showing a flow of processes from the start of a user using this system to the collection of a charge in the automated billing type information providing system of the present invention; and

FIG. 4 is a diagram schematically illustrating a conventional prepaid card insertion type TV.

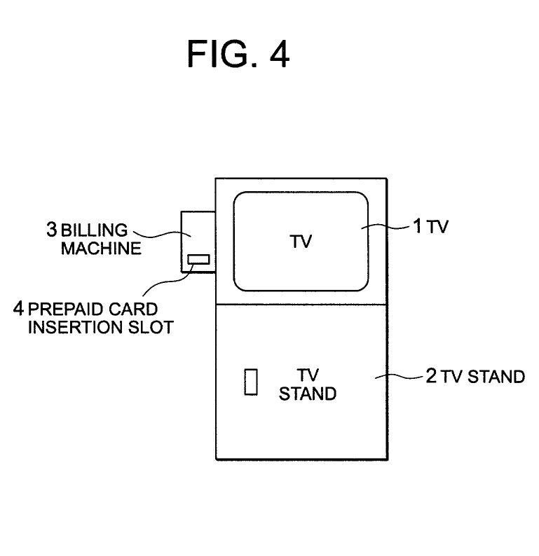

### DETAILED DESCRIPTION OF THE PREFERRED EMBODIMENT

A preferred embodiment of an automated billing type information providing system according to the present invention, will hereinafter be described in depth with reference to the drawings.

Note that the same components as those in the prior art system are marked with like numerals, of which repetitive explanations are herein omitted.

The automated billing type information providing system of the present invention may be applied to, for example, individual homes, hospitals, hotels, inns, schools, libraries and other public facilities.

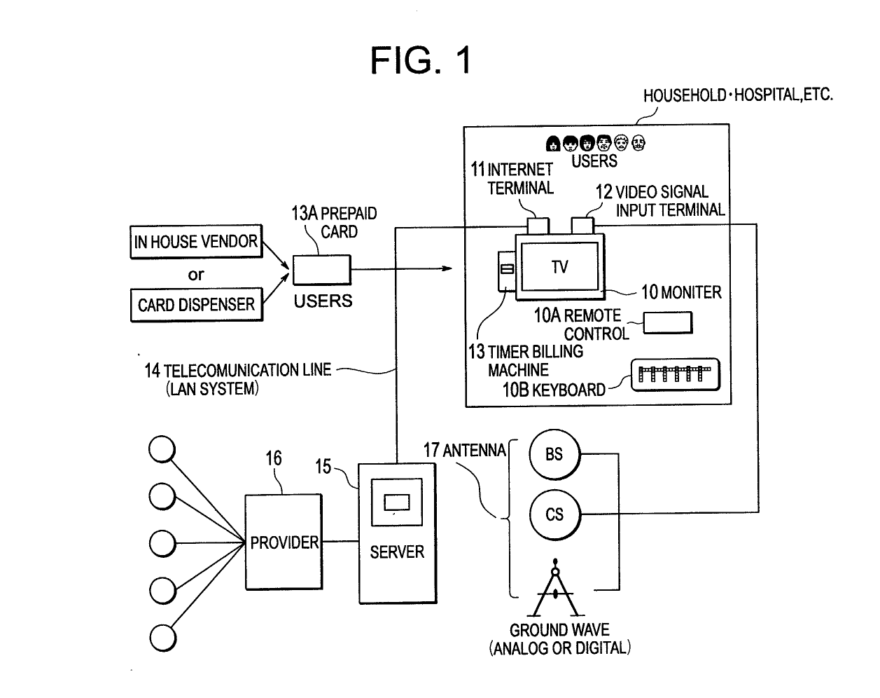

As illustrated in FIG. 1, according to the automated billing type information providing system of the present invention, a monitor 10 is loaned to a user under a contract based on a condition that a basic charge should be paid. Namely, this is a system whereby the user makes the contract with a vendor, and the monitor 10 is installed in the user's home, etc. The monitor 10 need not be an asset of the vendor, and it may be a system in which, for instance, a lender different from the vendor rents the monitor 10 to the user.

The monitor 10 is provided with an Internet terminal 11 and a video signal input terminal 12. The monitor 10 further includes a timer billing machine 13 serving as a billing unit. For example, a LAN system telecommunication line 14 is connected to the Internet terminal 11 and the telecommunication line 14 connects the monitor 10 to a provider 16 via a server 15.

Note that where monitors 10 are installed into individual homes, a single server 15 for a plurality of homes is provided outside the homes, and the installation of monitors 10 into the facilities such as a hospital ward the server 15 is provided within the ward.

Further, an antenna 17 serving as a signal receiving device constructed of, e.g., a BS (Broadcasting Satellite) antenna, a CS (Communication Satellite) antenna, or a digital or analog ground wave antenna, is connected to the video input terminal 12.

Moreover, the timer billing machine 13 classified as a prepaid card insertion type billing unit is so constructed as to be capable of adding up charges corresponding to the time of use of the monitor 10 and the type of application of the monitor 10.

Note that the monitor 10 is provided with a remote control 10A and a wireless keyboard 10B.

In the thus constructed automated billing type information providing system of the present invention, when a user inserts a prepaid card 13A into the timer billing machine 13, the machine 13 adds up the charges corresponding to how long and what the monitor 10 has been used for, and therefore allows the user to be provided with the information via the monitor 10 until no balance remains in the prepaid card 13A.

Further, the user is not only able to use the monitor 10 in a mode where video signals of normal TV broadcasting, BS and CS TV broadcasting, etc., are projected on the monitor 10 as in the prior art system, but also is able to use a mode of utilizing Internet information supplied via the telecommunication line 14.

Accordingly, by using the keyboard 10B, the user can also utilize a e-mail and chat services, he can also shop via the Internet.

Further, although FIG. 1 shows an architecture capable of utilizing the Internet, BS TV, CS TV , etc., the automated billing type information providing system of the present invention need not be so constructed as to be capable of utilizing all such functions, but may be constructed according to the interests of the user, e.g., to utilize only the Internet or to further provide BS TV, etc . . . Thus, the automated billing type information providing system is versatile enough to provide all possible combinations of those functions.

Further, the automated billing type information providing system is constructed so that the Internet, etc., can be utilized simply by payment through the prepaid card 13A once a fixed basic charge has been paid. Namely, the use charges added up by the timer billing machine and paid by the prepaid card contain the charges needed for using the Internet, etc.

Accordingly, in the process of adding up the charges by the timer billing machine 13, the charge may be set corresponding to the application selected from among those that can be utilized by the user on the monitor 10. For instance, a first charge is required for using only the Internet for a predetermined time, whereas when the monitor 10 is set in a mode to use BS TV as well as the Internet, a second charge higher than the first charge may be set. Further, the use charge may be set by lengthening or shortening the unit of time on which the predetermined charge is based corresponding to the application selected among those that can be utilized by the user on the monitor 10.

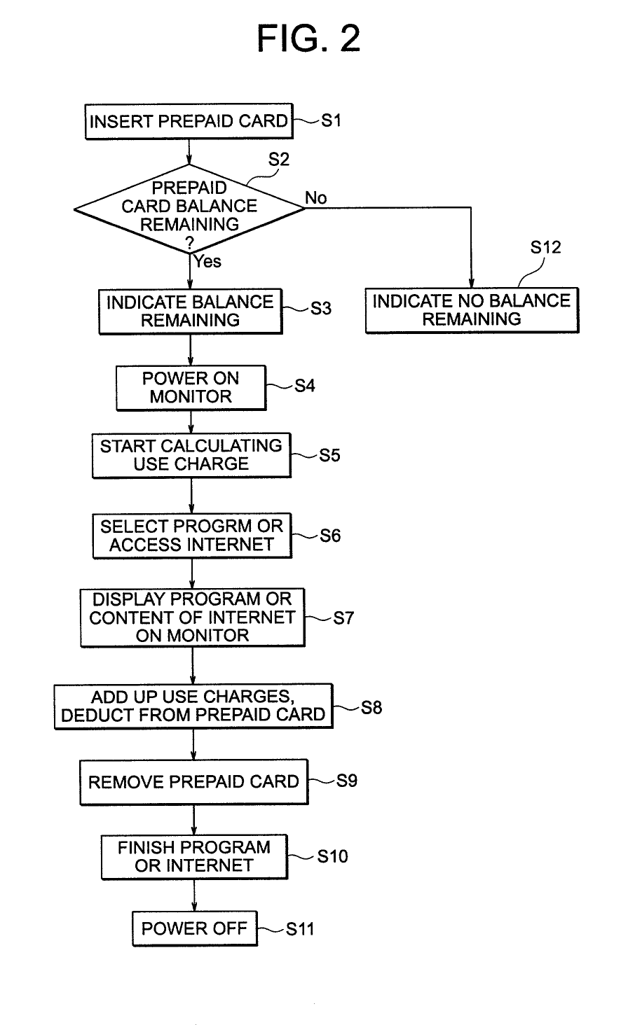

FIG. 2 is a flowchart showing how the user is provided with the information in the automated billing type information providing system according to the present invention. Note that the series of processes shown in FIG. 2 is premised on the user having contracted with the vendor (or lender), and the monitor 10 had been given (or loaned) to the user.

A shown in FIG. 2, the user inserts the prepaid card 13A into the timer billing machine 13 in step S1, and whether or not there is a balance remaining in the prepaid card is determined in step S2.

When it is determined in step S2 that the prepaid card has a balance remaining, the processing proceeds to step S3, it is indicated that there is a balance. Further, in subsequent step S4, the user can then switch ON the power source of the monitor 10.

Upon the power-on in step S4, the timer billing machine 13 starts calculating a use charge based on use time in step S5, and a program can be chosen or the Internet can be accessed in step S6.

Instep S7, the content of the Internet or the program selected in step S6 is displayed, and the charge is then added up in the next step S8, and this amount of money is deducted from the prepaid card 13A.

Subsequently, when the user takes out the prepaid card 13A in step S9, the display of the program or the Internet on the monitor 10 disappears, and the power source is switched OFF in step S11.

Further, if it is determined in step S2 that the prepaid card 13A has no balance remaining, an indication of no balance is given on the timer billing machine 13, and the user is not allowed to use the system.

As discussed above, according to the automated billing type information providing system of the present invention, the user can not only utilize the information in a variety of categories as on the Internet, etc., but he can also obtain such information in an extremely handy manner at a low cost because the charges such as Internet connection fees can be paid by use of a prepaid card.

Further, in the discussion given above, the condition for using this system is the payment of the fixed basic charge. However, the payment of the basic charge need not be set as a condition, and the use charges to be paid by the prepaid card 13A may contain not only the charge for using the Internet, etc. but also the rental charge for the monitor body 10. In this case, the procedures for the user paying the basic charge can be further simplified, and hence the user can be provided with a system having even greater usability.

Further, the method of paying the use charges is not limited to prepaid cards but may include a cash payment method. Further, payment methods by which data about the charges added up by the timer billing machine 13 are transmitted to a financial institution such as a bank, a post office (savings division), etc. or a non-bank financial institution such as a consumer loan company, etc. via the provider 16, and a bill is sent to the user, and a payment method for deducting automatic payments from a user's account are all possible.

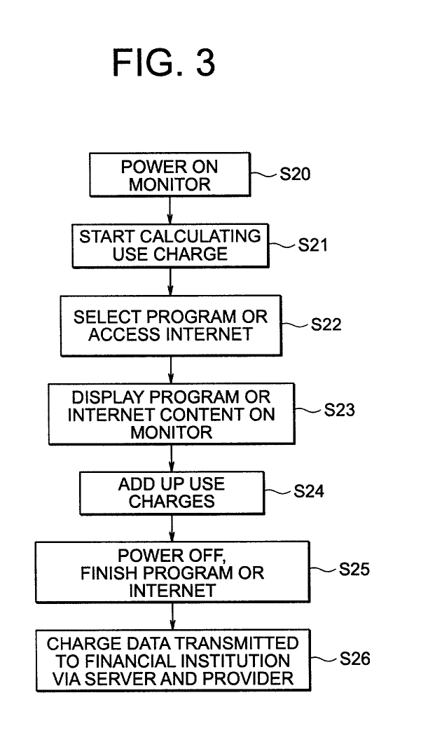

In the case of such deferred payment methods, the user may receive, for example, the data in the flow of processes shown in FIG. 3. Note that the timer billing machine 13, according to this method, has no prepaid card insertion slot, and the use charges may be transmitted through the telecommunication line 14 to the financial institution, etc. via the provider 16.

In step S20 shown in FIG. 3, the user switches ON the power source of the monitor 10, and in step S21 the timer billing machine 13 starts calculating the use charge.

When the user chooses a program or accesses the Internet in step S22, the program or content of the Internet is displayed on the monitor 10 in step S23, and in step S24 the timer billing machine 13 adds up the use charges.

Then, the user switches OFF the power source in step S25, thereby finishing the program or the Internet. In step S26, the timer billing machine 13 transmits the data indicating the use charges to the financial institution, etc. through the telecommunication line 14, and the use charges will be deducted from the user's account later on. Thus, the collection of the charges in the automated billing type information providing system of the present invention may be made by the deferred payment method.

Moreover, according to the automated billing type information providing system of the present invention, since a LAN system line is used as the telecommunication line, a labor for connecting the line can be saved as compared with a dial-up type line. Moreover, since the monitor 10 is always connected to the provider 16, information can be promptly obtained.

Note that even though the case of using a LAN type line as the telecommunication line 14 was discussed above, the telecommunication line 14 is not limited to LAN system lines but may include the use of optical fiber cables, high-speed Nets, ISDN lines, etc., and further dial-up types may also be used.

The automated billing type information providing system according to the present invention includes the monitor loaned to the user and connected to the provider through the telecommunication line via the server, the signal receiving unit for receiving the video signals output to the monitor, and the billing unit for integrating Internet use time through the telecommunication line or projection time for which video signals are projected on the monitor through the signal receiving unit and calculating the use charge based on the result of this integration. The user pays the use charge calculated by the billing unit and is thereby allowed to utilize the Internet through the telecommunication line and to at least view the video signals on the monitor. The user is therefore able to obtain the information in a variety of categories in an extremely handy manner at low cost. Further, the telecommunication line is based on the LAN system, which saves labor for the connection as compared with a dial-up type line, and the monitor can be connected to the provider at all times, whereby the user can promptly obtain information. The monitor can be installed in individual homes, with a single server for the plurality of homes can be provided outside the homes, and the user can therefore obtain the information in a variety of categories in an extremely handy manner at low cost. A plurality of monitors may also be installed in a ward with a server set in the ward, and the user is therefore able to obtain information in a variety of categories in an extremely handy manner at the low cost. Further, the billing unit is installed together with the monitor on the user's side, and the use charges are paid using a prepaid card system, and the user can therefore obtain the information in a variety of categories in an extremely handy manner at low cost. It is also feasible to provide a system exhibiting great versatility and high security. Moreover, the billing unit may be constructed so that the results of the integration are transmitted to the provider through the telecommunication line, and the user billed for the use charges based on the results of the integration transmitted to the provider making it possible to provide the automated billing type information providing system exhibiting the high versatility and the high security. The provider may also be connected to a financial institution or a non-bank financial institution, so that the data representing the use charges can be transmitted to the financial institution or the non-bank financial institution. The use charges automatically debited from the user's account, so that an automated billing type information providing system easily utilized by the user can be provided. Moreover, the billing unit may be installed together with the monitor on the user's side, and the use charges are paid in cash, therefore making it possible to provide an automated billing type information providing system easily utilized by the user.

What is claimed is:

1. An automated billing type information providing system comprising:
a monitor loaned to a user and connected to a provider through a telecommunication line via a server;
a signal receiving unit for receiving video signals output to said monitor; and
a billing unit for integrating Internet use time through the telecommunication line or projection time for which the video signals are projected on said monitor through said signal receiving unit, and calculating a use charge based on a result of this integration,
wherein a user pays the use charge calculated by said billing unit and is thereby allowed to utilize the Internet through the telecommunication line and to at least view the video signals on said monitor.

2. An automated billing type information providing system according to claim 1, wherein the telecommunication line is composed of a LAN system.

3. An automated billing type information providing system according to claim 1 or 2, wherein said monitors are installed in individual homes, and said server for a plurality of homes is provided outside the homes.

4. An automated billing type information providing system according to claim 1 or 2, wherein a plurality of said monitors are installed in a hosipital ward, and said server is also installed in the ward.

5. An automated billing type information providing system according to any one of claim 1, said billing unit is installed together with said monitor on the user's side, and the use charges are paid by using a prepaid card.

6. An automated billing type information providing system according to any one of claim 1, wherein said billing unit is constructed so that the result of the integration are transmitted to said provider through the telecommunication line, and the user is billed for the use charges based on the results of the integration transmitted to said provider.

7. An automated billing type information providing system according to claim 6, wherein said provider is connected to a financial institution or a non-bank financial institution,
the data representing the use charges are transmitted to the financial institution or the non-bank financial institution, and
the use charges are automatically debited from the user's account.

8. An automated billing type information providing system according to any one of claim 1, wherein said billing unit is installed together with said monitor on the user's side, and the use charges are paid in-cash.
